(19) United States
(12) Patent Application Publication
(10) Pub. No.: US 2008/0004896 A1
(43) Pub. Date: Jan. 3, 2008

(54) Methods and systems for algorithmic order processing

(76) Inventors: Derek Lance Gover, Glencoe, IL (US); Joseph de Castelnau, Aurora, IL (US)

Correspondence Address: MORGAN LEWIS & BOCKIUS LLP, 1111 PENNSYLVANIA AVENUE NW, WASHINGTON, DC, 20004, US

(21) Appl. No.: 11/803,812

(22) Filed: May 15, 2007

Related U.S. Application Data
(60) Provisional application No. 60/800,700, filed on May 16, 2006.

(51) Int. Cl. G06Q 99/00

(52) U.S. Cl. 705/1

(57) ABSTRACT

In one aspect, the invention comprises a method comprising: (a) receiving a securities trading order comprising core parameters and strategy parameters in a first format; (b) translating said order into a form wherein said core parameters and said strategy parameters are separated into distinct groups of parameters; (c) processing said core parameters; and (d) transmitting said translated order to said order management system. In another aspect, the invention comprises a computer system comprising: (a) an order component operable to receive a securities trading order comprising core parameters and strategy parameters in a first format; (b) a translation component operable to translate said order into a form wherein said core parameters and said strategy parameters are separated into distinct groups of parameters; (c) a processing component operable to process said core parameters; and (d) a transmission component operable to transmit said translated order to said order management system.

### CROSS REFERENCE TO RELATED APPLICATIONS

This application claims priority to U.S. Provisional Patent Application No. 60/800,700, filed May 16, 2006. The entire contents of that provisional application are incorporated herein by reference.

### INTRODUCTION

In at least one embodiment, the invention processes algorithmic securities trading orders by splitting the parameters of an order into two parts: Core and Algorithmic. Doing so renders the translation of the algorithmic fields unnecessary, allowing a non-FIX based trading system to be process the fields it deems “core” while passing along the order's algorithmic parameters to an electronic destination for which the order in its original form was intended.

Orders

An order represents a customer's intention to buy or sell a security. The securities are bought and sold on trading venues, each of which supports a standard set of “order types” that allow the customer to specify instructions on how the order is to be filled.

The basic properties of an order (ticker symbol, side (buy or sell), quantity, expiration, order type, and route) are considered “core parameters.” The implementation of some simple order types may require a simple algorithm, but since these types are so standard, no one refers to them as algorithmic orders.

FIX

“FIX” stands for Financial Information Exchange, a standard protocol used to communicate data for trading securities via computer software. It is based on agreed-upon standards of communication between traders/firms. FIX is the electronic language used, for example, to transmit a buy order of 100 shares of Microsoft, to check on the status of that order, to cancel that order, or to reject that order.

Algorithmic Orders

Algorithmic orders are orders with additional handling/execution instructions that (typically) are more complex than those supported by the trading venue. An algorithmic engine is maintained by the provider—usually a broker/dealer—and resides between the customer and the trading venues (the algorithm being used may send parts of the customer's order to different venues based on market conditions). Algorithms may be simple or complex, and may do one or more of the following:
1. Send out large orders in small chunks.
2. Send out portions of an order at various times during the day.
3. Scan available venues for optimal prices.
4. Look at market indices and other indicators to determine when to: (a) start/stop placing trades; and/or (b) be more passive/aggressive.
5. Look at historical volume trends to determine the best time of day to trade.
6. Try to fill an order on one venue, and then try to fill the remainder on another.

Algorithmic Parameters

For the purposes of this description, all parameters specific to an algorithm's strategy are referred to as “algorithmic parameters.”

Each algorithmic provider may offer multiple strategies. The logic behind each strategy may be complex and rely on various parameters. The provider typically allows the customer to configure a subset of the parameters that the algorithmic engine actually uses. This may be done to hide proprietary information (to stop the customer from doing the same thing himself), or to simplify the use of the algorithm, or both. For some strategies, the provider may not allow the customer to specify anything other than the name of the strategy. For others, the customer may be allowed to enter dozens of parameters.

Regardless of the complexity inherent to algorithmic orders, a preferred trading system parses each algorithmic order to determine the core parameters. A preferred trading system preferably leaves the remaining parameters intact and passes them along to the algorithmic destination in its desired format.

Algorithmic Challenges

More and more brokers are offering algorithmic trading strategies to their customers, and time-to-market is an important consideration for trading systems. Also, the providers are continually adding new strategies and tweaking old ones. Indeed, according to many industry analysts, broker algorithm customization will soon become a significant differentiating factor. Trading systems—especially order routing systems—need to develop new client-side (e.g., RealTick) and server-side (e.g., Exchange Handler) technology in order to support new algorithms or changes to old ones. Work on the client side typically involves adding an interface to set/adjust the algorithmic parameters and tack the algorithmic parameters onto a core order. On the server side, all the order parameters must be translated into the format required by the trading venue. The majority of the algorithmic providers use the FIX protocol today. FIX has its own concepts of core parameters, and allows for vendor-specific data, which preferably is how the algorithmic parameters are passed along to the provider.

Rolling out new client and server software takes time, and keeping up with the latest changes to an existing algorithm is a never-ending battle. Since the parameters of each algorithm are of little or no use to client and server software of an order routing system, it would save a lot of work and speed up our time-to-market if changes/additions to algorithms did not require new versions of the client and server software.

Industry Trends

The FIX standards committee is working on coming up with a standard way for algorithmic providers to describe their algorithms so that the interfaces needed to enter/edit algorithmic orders can be generated automatically from a schema of some sort. The schema would also describe how to pass the parameters along using the FIX protocol. The schema may be made available via a web service, so that schema changes do not require client upgrades. This solution may be useful to FIX-based trading systems, but for order routing systems that do not use FIX for communication between client applications and servers, it is impractical.

An embodiment of the present invention provides a solution to this problem by splitting algorithmic orders into two parts—core parameters and algorithmic parameters. An order routing system can take into account or otherwise process the core parameters while treating the algorithmic parameters as a “black box” that is passively passed along with each order.

In an embodiment based on XML, an XML format used for the algorithmic parameters maps the XML tags directly to FIX tags. When combined with the above method of algorithmic schemas obtained via web service calls, this embodiment results in a system operable to handle algorithmic strategies without requiring client or server upgrades, and that will require a non-FIX-based trading system to be rewritten to use FIX for communication between client and server software.

In one aspect, the invention comprises a method comprising: (a) receiving a securities trading order comprising core parameters and strategy parameters in a first format; (b) translating the order into a form wherein the core parameters and the strategy parameters are separated into distinct groups of parameters; (c) processing the core parameters; and (d) transmitting the translated order to the order management system.

In various embodiments: (1) the first format is XML; (2) the translating step further comprises translating the order into a second format compatible with an order management system; and (3) the second format is FIX.

In another aspect, the invention comprises software stored on a computer readable medium, the software comprising: (a) software for receiving a securities trading order comprising core parameters and strategy parameters in a first format; (b) software for translating the order into a form wherein the core parameters and the strategy parameters are separated into distinct groups of parameters; (c) software for processing the core parameters; and (d) software for transmitting the translated order to the order management system.

In various embodiments: (1) the first format is XML; (2) the software for translating further comprises software for translating the order into a second format compatible with an order management system; and (3) the second format is FIX.

In another aspect, the invention comprises a computer system comprising: (a) an order component operable to receive a securities trading order comprising core parameters and strategy parameters in a first format; (b) a translation component operable to translate the order into a form wherein the core parameters and the strategy parameters are separated into distinct groups of parameters; (c) a processing component operable to process the core parameters; and (d) a transmission component operable to transmit the translated order to the order management system.

In various embodiments: (1) the first format is XML; (2) the translation component is further operable to translate the order into a second format compatible with an order management system; (3) the second format is FIX; (4) the system further comprises one or more order handlers for mapping strategy XML fields to a FIX protocol; (5) the order component comprises a web server; and (6) the order component comprises a workstation in communication with a computer network.

### BRIEF DESCRIPTION OF DRAWINGS

FIG. 1 depicts an exemplary system and algorithmic order flow for an embodiment of the present invention.

FIG. 2 depicts a graphical representation of an exemplary core order.

FIG. 3 depicts an exemplary graphical interface for an exemplary algorithmic order.

### DETAILED DESCRIPTION

The server-side piece responsible for sending the algorithmic order to the destination will treat the order the same as a standard order, except that it will tack on the algorithmic parameters from the embedded XML. The embedded XML will contain the FIX tags, so changes to the algorithm will not require changes to this piece—just an update of the schema used in packing the parameters into XML. The strategy XML piece can also contain an additional section for XML parameters for use with algorithms that do not use FIX tags. The concept is the same in this case—changes in the algorithmic protocol will not require changes to the server-side piece.

Removing the need for server and client development speeds up time-to-market for implementation of new algorithms and changes to existing ones.

Order Flow

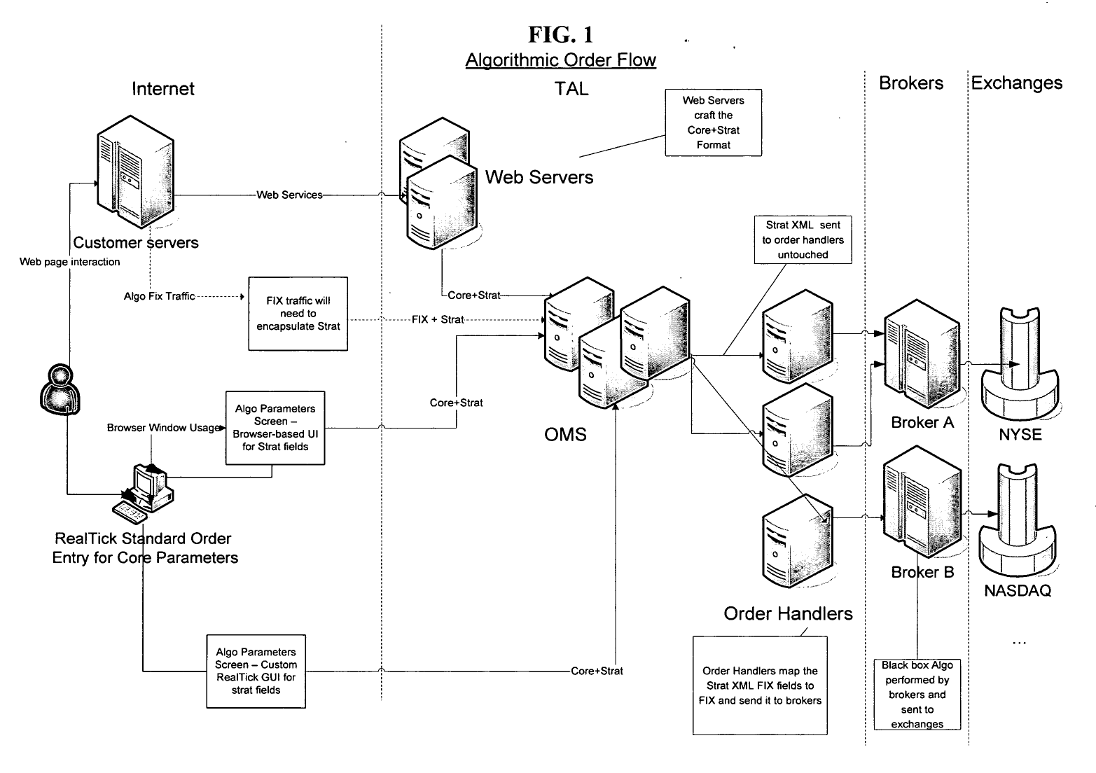

FIG. 1 depicts algorithmic order flow of an embodiment of the present invention:

A user can instruct the system to start an algorithmic order either through a trading application such as RealTick or through a Web browser.

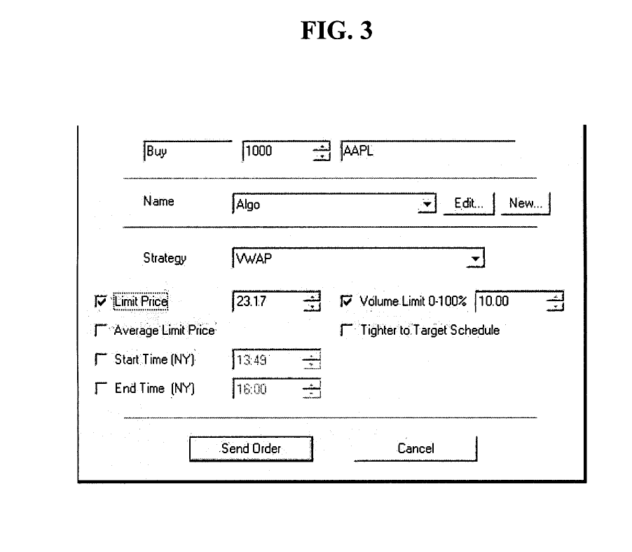

In a client application such as RealTick, the user is presented with algorithmic parameters choices such as the ones depicted in FIG. 3 through a native (usually called fat-client) Graphical User Interface or through an embedded web page.

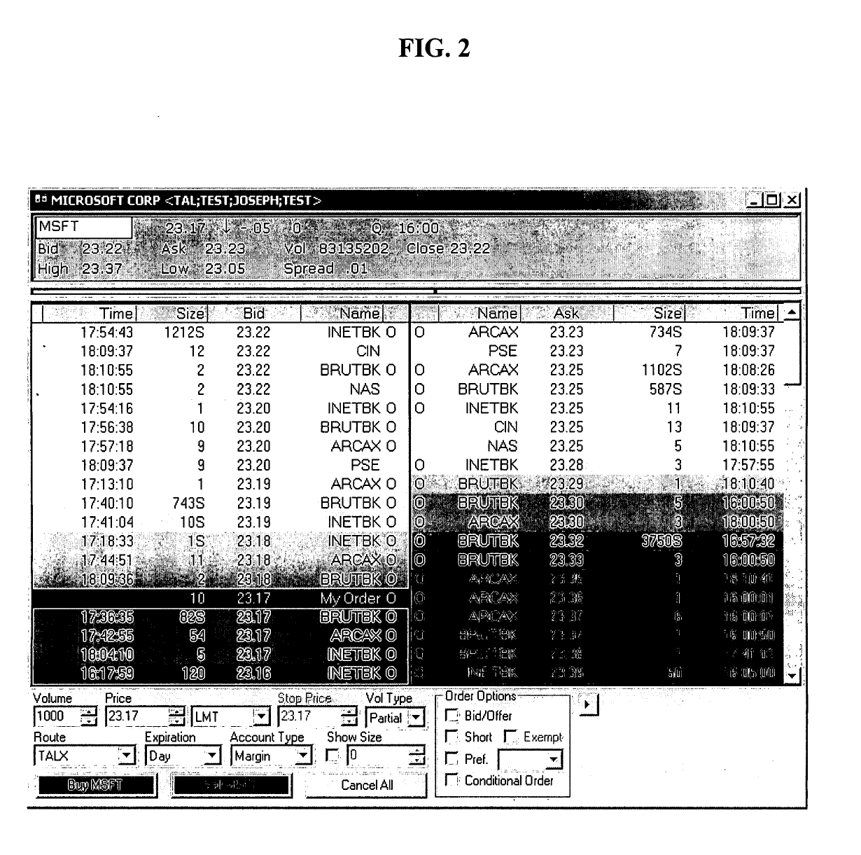

After the user makes his choice of parameters and submits the order, the system (client and server) will process the core order parameters (see the example depicted in FIG. 2) and strategy parameters all the way through the broker exchange order handlers.

The process flow for web page interaction is similar, with the web servers being tasked to do the Core & Strategy parameters processing.

The following is a list of exemplary entry points to algorithm order flow (see FIG. 1):
1) RealTick algorithmic DLLs.
2) RealTick spawning a browser window to configure the algorithmic parameters, hosted by the broker who created the algorithmic order.
3) Web service call directly into the trading system.
4) Web browser window offering pre-trade analytics type services embedded in RealTick and sending client-side scripting calls to RealTick to generate algorithmic orders.
5) Direct FIX traffic.

Specifications

Separation between the core fields and the algorithmic strategy fields may be accomplished, for example, by an order routing engine either within order routing software (e.g., RealTick) or in a web server.

FIG. 2 depicts a graphical representation of an exemplary core order. The order details are shown in area 210 of FIG. 2.

FIG. 2 represents the core part of the order in the graphical representation under the colored tiers. All of the core fields graphically represented are spelled out below.

An equivalent of the order shown in FIG. 2 is described below, in coded format (a simplified representation of a preferred binary format):

Core data (the numbers in parentheses are the field IDs as represented within the core binary format):

SecType(2000):1

Bank(20001):TAL

Branch(20003):TEST

Customer(20008):JOSEPH

Deposit(20052):TEST

User(20405):JDECASTELNAU@SBDEMO (not shown above)

Symbol(1003):MSFT

LimitPrice(20403):23.17

Buy/Sell(20677):Buy

Quantity(20401):1,000 (10 is the representation in hundreds)

OrderType(20680):AsEntered (means limit order—shown above)

BaseCode(20403):3500 (internal representation)

OrderExpiration(20678):Day (will expire at the end of the day)

Core+Strategy Fields Example

FIG. 3 depicts an exemplary graphical interface for an algorithmic order.

Each parameter in the GUI depicted in FIG. 3 corresponds to an XML Strat field as indicated below:

An embodiment of the present invention translates that order into:

<order>
//Core fields

<field fid=“2000” type=“short” >1</field> -> Security Type (1 means stock)
<field fid=“20001” type=“string” >TAL</field> -> Bank / 1^{st} Acct field
<field fid=“20003” type=“string” >TEST</field> -> Branch / 2^{nd} Acct field
<field fid=“20008” type=“string” >JOSEPH</field> -> Customer / 3^{rd} Acct field
<field fid=“20052” type=“string” >TEST</field> -> Deposit / 4^{th} Acct field
<field fid=“20405” type=“string” >JDECASTELNAU@SBDEMO</field> ->user

and domain

<field fid=“1003” type=“string” >APPL</field> -> Ticker Symbol
<field fid=“20677” type=“string” >Buy</field> -> Buy/Sell
<field fid=“20401” type=“long” >1000</field> -> Quantity
<field fid=“20680” type=“string” >Limit</field> -> Price Type of order
<field fid=“20403” type=“double” >23.17</field> -> Limit Price
<field fid=“20678” type=“string” >DAY</field> -> How long the order is valid

//Strategy field

```
<stratParameters>
  <field tag=“847” type=“string” >VWAP</field> -> Strategy type
  <field tag=“849” type=“double” >10.00</field> -> Volume Limit % field
  <field name=“NameToStore” type=“string” >Algo</field> -> Name to store the
```

field

</stratParameters>

</order>

The stratParameters section preferably may include 3 types of tag:

Named FIX tag:
<field tagName=“TargetStrategy” type=“string” >VWAP</field>
ID'ed FIX tag:
<field tag=“847” type=“string” >VWAP</field>
TAL proprietary tag:
<field name=“MyParameter” type=“string” >FOO</field>
(no “tag” keyword in the attribute)
Note that the actual FIX tags used by different algorithmic order providers
may vary.

It will be appreciated that the present invention has been described by way of example only, and that improvements and modifications may be made to the invention without departing from the scope or spirit thereof. For example, order management and routing systems other than those that XML may be used, and order management and execution systems other than those using FIX may be used, without departing from the scope of the invention.

What is claimed is:

1. A method comprising:
receiving a securities trading order comprising core parameters and strategy parameters in a first format;
translating said order into a form wherein said core parameters and said strategy parameters are separated into distinct groups of parameters;
processing said core parameters; and
transmitting said translated order to said order management system.

2. A method as in claim 1, wherein said first format is XML.

3. A method as in claim 1, wherein said translating step further comprises translating said order into a second format compatible with an order management system.

4. A method as in claim 3, wherein said second format is FIX.

5. Software stored on a computer readable medium, said software comprising:
software for receiving a securities trading order comprising core parameters and strategy parameters in a first format;
software for translating said order into a form wherein said core parameters and said strategy parameters are separated into distinct groups of parameters;
software for processing said core parameters; and
software for transmitting said translated order to said order management system.

6. Software as in claim 5, wherein said first format is XML.

7. Software as in claim 5, wherein said software for translating further comprises software for translating said order into a second format compatible with an order management system.

8. Software as in claim 7, wherein said second format is FIX.

9. A computer system comprising:
an order component operable to receive a securities trading order comprising core parameters and strategy parameters in a first format;
a translation component operable to translate said order into a form wherein said core parameters and said strategy parameters are separated into distinct groups of parameters;
a processing component operable to process said core parameters; and
a transmission component operable to transmit said translated order to said order management system.

10. A system as in claim 9, wherein said first format is XML.

11. A system as in claim 9, wherein said translation component is further operable to translate said order into a second format compatible with an order management system.

12. A system as in claim 11, wherein said second format is FIX.

13. A system as in claim 9, further comprising one or more order handlers for mapping strategy XML fields to a FIX protocol.

14. A system as in claim 9, wherein said order component comprises a web server.

15. A system as in claim 9, wherein said order component comprises a workstation in communication with a computer network.
